(19) United States
(12) Patent Application Publication
(10) Pub. No.: US 2005/0093681 A1
(43) Pub. Date: May 5, 2005

(54) Set for automatically reading an information and for remote control or monitoring system comprising at least such a set

(76) Inventors: Sophie Masclet, Sevres (FR); Nicolas Gaillotte, Saint-Maur-Des-Fosses (FR)

Correspondence Address: Blakely Sokoloff;Taylor & Zafman, 7th Floor, 12400 Wilshire Boulevard, Los Angeles, CA, 90025, US

(21) Appl. No.: 10/312,116

(22) PCT Filed: Jun. 21, 2001
(86) PCT No.: PCT/FR01/01953

(30) Foreign Application Priority Data
Jun. 22, 2000 (FR) 00/08000

(51) Int. Cl. H04Q 5/22

(52) U.S. Cl. 340/10.42; 340/10.52; 340/825.69

(57) ABSTRACT

The invention concerns a set for automatically reading an information carried by data storage means adapted to be read, comprising a reading module connected to a mobile telephone terminal, the mobile telephone terminal comprising means for triggering reading by said module of the information carried by the data storage means, the reading module including means for transmitting to the mobile telephone terminal a signal bearing the read information. The information carried by the storage means comprises a code identifying a mobile element whereon said storage means are recorded and the mobile telephone terminal comprises means for triggering and managing a sequence of operations comprising successively: reading said code by the reading module; transmitting said code, by said telephone terminal, to a remote management server. The invention is applicable to remote monitoring or control, in particular remote control of parking fee payment.

The present invention relates to a system for automatically reading data and to a control or remote monitoring system comprising at least one such system.

The invention finds particular application in remote control of the payment of parking fees and also in the remote identification and monitoring of moving objects.

Systems for the remote payment of parking fees are already well known.

With such systems, the user, when he is parking, calls, for example on his mobile phone, a fee-paying centre which identifies the user and, where appropriate, the geographical area in which he is parking his vehicle.

His call triggers payment of a sum corresponding to a given parking time.

To check that vehicles parking in a given area have duly paid a parking fee at a given time, the control staff remotely interrogate the server by giving it, for example, the number of the vehicle being checked. In response, the server indicates whether the vehicle in question is recorded in its database as having made an advance payment of a parking fee.

In order to simplify the operation whereby the control staff note the numbers of the vehicles and sends them by telephone to the server, it has already been proposed to equip the operators with automatic reading devices to read the identification devices, for example bar codes, carried by the vehicles. These automatic reading devices include a terminal which handles the reading of the identification code and the exchanges with the server and which includes an interface to enable the control staff to initiate a sequence of reading identification codes and interrogation of the server.

The terminal and its interface are specifically dedicated for this purpose.

Equipment such as this has the major disadvantage of being bulky and impractical for the operators.

The invention proposes a system for automatically reading data contained in a bar code label or transponder or similar data storage device that is very simple to use and less bulky.

This system can be used to advantage for the remote monitoring of moving objects or for checking them.

The invention therefore proposes a System for automatically reading data stored in data storage devices that can be read, characterised in that it incorporates a read module connected to a mobile telephone terminal incorporating means for initiating the reading by the said module of the data stored in the data storage device, the read module incorporating means for transmitting a signal carrying the data read to the mobile telephone terminal.

In particular, the data stored in the storage device can include a code to identify a moving object to which the said storage device is attached and whereby the mobile telephone terminal incorporates means for initiating and handling a sequence of operations including in order:
reading of the said code by the read module,
transmission of the said code by the said telephone module to a remote management server.

In addition, the said sequence of operations has the benefit of including:
transmission to the user of the telephone terminal of a message transmitted in reply by the management server to the said terminal.

The system proposed by the invention also benefits from the inclusion of the various following characteristics taken alone or in all their various possible combinations:
the read module is mechanically attached to the mobile telephone module;
the mechanical attachment of the read module is removable;
the telephone terminal incorporates an operating system that displays on the screen of the said terminal data read by the read module and/or a message transmitted in response by the said server to the said terminal.
the read module and the data storage device incorporate a device to permit the said module to record the data in the said storage device;
for the remote control of the payment of parking fees, it incorporates a system of the abovementioned type, the data stored by the storage device including a vehicle identification code, the server being a server for the management of the payment of parking fees.

The invention also concerns a read module for a system in accordance with one of the preceding claims, characterised in that it incorporates means for connection to the mobile telephone terminal of such a system, as well as devices for transmitting the data read to this mobile telephone terminal.

It has the advantage of including firstly transmitting/receiving systems that are able to transmit an interrogation signal to the data storage devices of the transponder type and to receive the signal transmitted in response by the latter, and secondly devices that are linked to these transmission/reception devices and that handle the exchanges of the said module with the mobile telephone terminal.

Preferably, it incorporates means for mechanically attaching it to a mobile telephone terminal of a system of the type described above.

In addition, the invention also proposes a mobile telephone terminal, characterised in that the said terminal is a telephone terminal for a system of the type described above and incorporates means for initiating reading by a module connected to the said terminal of data stored in the data storage device.

The data stored in the storage device has the advantage of including the identification code of a moving object to which the said storage device is attached, the said terminal incorporating means for initiating and handling a sequence of operations including in order:
reading the code by the read module,
transmission of the said code by the said telephone terminal to a remote management server.

Preferably, the said sequence of operations also includes:
transmission to the user of the telephone terminal of a message transmitted in response by the management server to the said terminal.

Finally, the invention also proposes a system for the monitoring of moving objects or their remote control, incorporating a remote management server, devices that can be attached to moving objects for their identification, devices for automatically reading a code stored by these identification devices and for the remote interrogation of the management server, characterised in that the devices incorporate a code reading module connected to a mobile telephone terminal, the code reading module incorporating means for transmitting the code read to the mobile telephone terminal, the said mobile telephone terminal incorporating means for initiating and handling a sequence of operations including in order:
reading by the said module of the code stored by the identification device,
transmission of the said code to the management server by the said telephone terminal,
transmission to the user of the telephone terminal of a message transmitted in response by the said database to the said terminal.

In particular, the invention proposes a system for the remote control of the payment of parking fees, characterised in that it consists of a system of the type described above, the means for identification being able to be attached to the vehicles, the server being a server for the management of remote payment of parking fees that is able to check whether the fees for a vehicle whose code has been transmitted have been paid.

Other characteristics and advantages of the invention will become clear from the description that follows, which is purely illustrative and not exhaustive and which should be read in connection with the attached drawings in which:

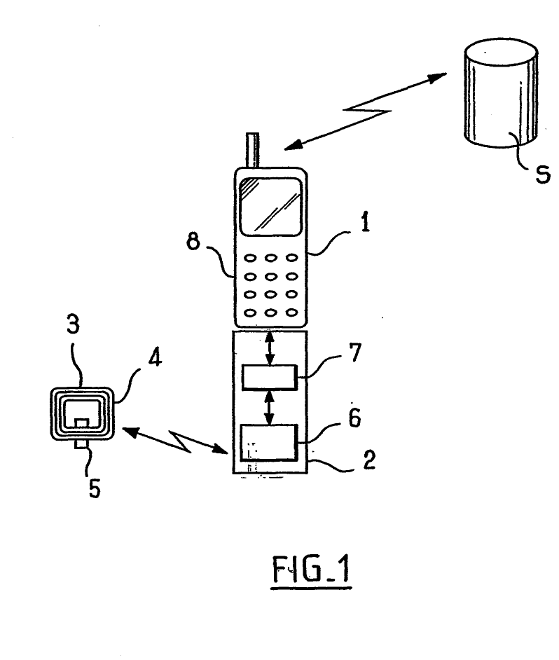

FIG. 1 is a diagrammatic representation illustrating the principle of a system in accordance with one possible method of implementation of the invention;

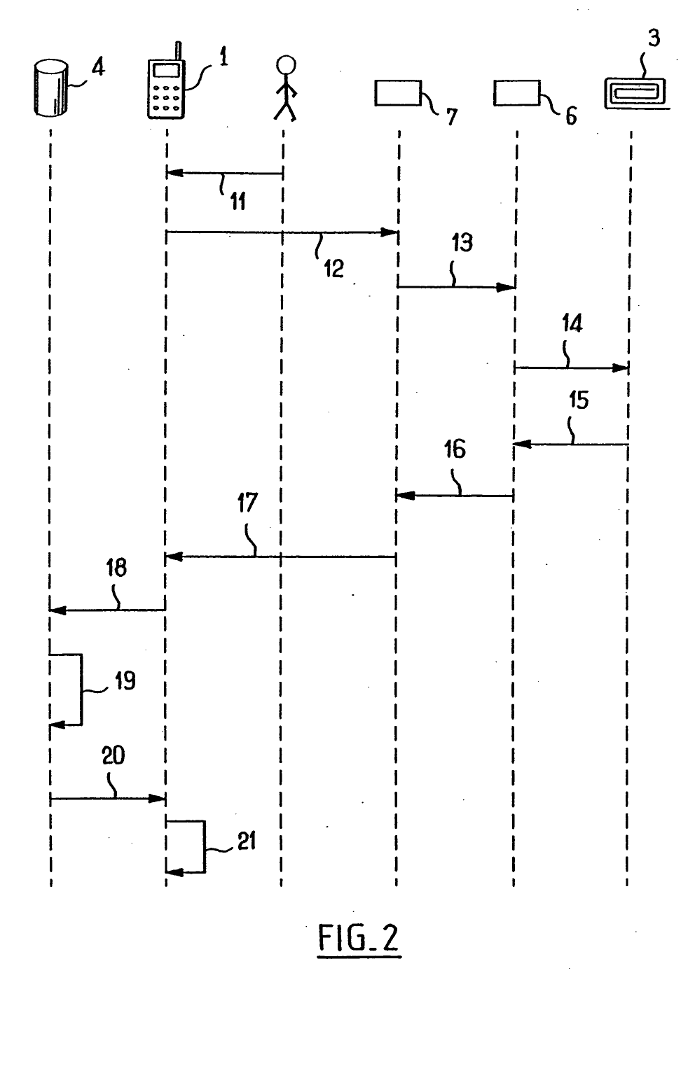

FIG. 2 is a diagrammatic representation illustrating the exchanges between the various elements of the system in FIG. 1.

The control system illustrated in FIG. 1 includes a server S for managing parking fees and a mobile telephone terminal 1 to which is mechanically and electrically connected a module 2 that is able to read an identification code stored in the device 3, itself intended to be attached to a motor vehicle.

Here, a mobile telephone terminal means any classical mobile terminal permitting radio communication such as a mobile telephone with a keypad and screen or a terminal of the personal assistant type with a built-in communication system.

The device 3 consists of a cheap transponder label comprising an antenna winding 4 and a memory 5, the transponder label being for example stuck to the windscreen of the vehicle.

The module 2 for reading the code stored in the memory 5 incorporates a transmission/reception device 6 for radio-frequency signals that is able to transmit an interrogation signal to a transponder label 3 and to receive the signal transmitted in response by the latter.

It also incorporates a device 7, linked to the transmission/reception device 6 which handles exchanges between the said module 2 and the mobile telephone module 1.

In addition, the module 2 and the portable telephone terminal 1 incorporate additional means for mechanically fixing the said module 2 to the portable terminal 1. This fixing is preferably of the removable type.

The mobile telephone terminal 1 itself incorporates means 8 enabling an operator to activate the said terminal to initiate and manage a sequence of operations comprising in order:
reading by the said module 2 of the code stored in the identification device 3, the code read being transmitted by the said module 2 to the portable telephone terminal 1,
transmission of the said code to the management server S by the said portable telephone terminal 1,
display of a message transmitted in response by the control server 1 to the said portable telephone terminal 1,

The device 8 consists, for example, in special programming of the SIM card.

As shown in FIG. 2, the operation of the system just described is as follows:
In the first step, (step 11), the operator activates the keypad of his mobile telephone terminal in order to initiate a control sequence.

For this reason, it is for example planned that this person can select a particular choice from a menu that is displayed on the screen of his portable telephone terminal.

When such an action is detected by the mobile telephone terminal 1, the latter transmits to the device 7 in the module 2 a request to read the code (step 12).

On receipt of this request, the device 7 initiates the transmission of an interrogation signal by the device 6 (steps 13, 14) and waits for the latter to transmit the code transmitted in response by the interrogated transponder label 3 (steps 15, 16).

On receipt of the code provided in response by the label 3, the latter is transmitted by the device 7 to the portable telephone terminal 1 (step 17), which transmits to the server S a message (step 18) requesting the said server S to check that the parking fees have been effectively paid for the vehicle corresponding to the code transmitted (step 19).

In response, the server S transmits to the mobile telephone terminal 1 a message (step 20) which is displayed on the screen of the mobile telephone terminal 1 and which indicates to the operator whether the parking fees have been paid or not (step 21).

Depending on the technology of the telephone, the message may be of the SMS (Short Message Service, in accordance with the anglo-saxon terminology currently in use) GPRS or UMTS type.

Thus, the operator can carry out a check on payment of the parking fees in real time using equipment that is very simple to handle and less bulky.

Other different implementations and applications from those just described can be envisaged.

In particular, in the case where the identification device 3 is of the transponder type, it could be arranged that the read module 2 is able to write data into the memory 5.

For example, the said module 2 may transmit to the transponder, with the interrogation signal, data giving the date and time of the check; also, it could be arranged that the mobile telephone terminal 1 transmits to the device 7 in module 2, on receipt of the SMS signal transmitted by the sever S, data on the result of the check carried out.

The various data concerning the checking operations thus stored in the device 3 can then be read by the driver of the vehicle, using equipment provided for this purpose.

It will be noted that the invention has been described here in terms of a preferred application which is that of reading the vehicle identification code for checking parking fees, but is by no means limited to this single application.

Many other applications can be envisaged for a system comprising a read module connected to a mobile telephone terminal, the mobile telephone terminal incorporating means for initiating reading by the said module of data stored in the data storage device, the read module incorporating means for transmitting to the mobile telephone terminal a signal carrying the data read.

In particular, such systems can be cheaply used to identify and monitor, in particular remotely, moving objects such as wagons, containers, sensitive products, etc.

1. A system for automatically reading data stored in a data storage device that can be read, the data stored in the storage device identifying a moving object to which the said storage device is attached, the said system incorporating a read module connected to a mobile telephone terminal, the said read module incorporating means for reading the data stored in the storage device, characterised in that the mobile telephone terminal incorporates means for initiating reading by the said module of the data stored in the storage device, the read module incorporating means for transmitting a signal carrying the data read to the mobile telephone terminal.

2. A system in accordance with claim 1, characterised in that the data stored in the data storage device incorporates an identification code identifying the moving object to which the said data storage device is attached and in that the mobile telephone terminal incorporates means for initiating and managing a sequence of operations including in order:
reading of the said code by the read module,
transmission of the said code by the said telephone terminal to a remote management server.

3. A system in accordance with claim 2, characterised in that the said sequence of operations also includes:
transmission to the user of the telephone terminal of a message transmitted in response by the management server to the said terminal.

4. A system in accordance with one of the preceding claims, characterised in that the read module is mechanically fixed to the mobile telephone terminal.

5. A system in accordance with claim 4, characterised in that the mechanical fixing is removable.

6. A system in accordance with one of the preceding claims, characterised in that the telephone terminal incorporates an operating system that displays on a screen of the said terminal the data read by the read module and/or a message transmitted in response by the said database to the said terminal.

7. A system in accordance with one of the preceding claims, characterised in that the read module and the data storage device incorporate a device permitting the said module to record the data in the said storage device.

8. A system for the remote control of the payment of parking fees, incorporating a system for automatically reading data stored in the storage device that can be read, data stored in the storage device incorporating a vehicle identification code, the said system incorporating a read module connected to a mobile telephone terminal, the said read module incorporating means for reading the identification code stored in the storage device, characterised in that the mobile telephone terminal incorporates means for initiating the reading by the said module of the code stored in the storage device, the said system also incorporating a management server for remote payment to which the code is transmitted by the telephone terminal.

9. A read module incorporating means for reading identification data stored in the storage device, the said module incorporating means for connection to a telephone terminal, the means for reading the data stored in the storage device being able to be triggered by a mobile telephone terminal connected to the said module, the said module also incorporating means for transmitting the data read to the telephone terminal.

10. A read module in accordance with claim 9, characterised in that it incorporates firstly a transmit/receive device that is able to transmit an interrogation signal to the transponder type data storage device and receive the signal transmitted in response by the latter and secondly a device that is connected to the transmit/receive device to handle the exchanges between the said module and the mobile telephone terminal.

11. A read module in accordance with claim 9 or 10, characterised in that it incorporates means for mechanically fixing it to the mobile telephone terminal of a system in accordance with one of claims 1 to 8.

12. A mobile telephone terminal, incorporating means for connecting it to a read module that is able to read the identification data stored in the storage device, characterised in that it incorporates means for initiating reading by the said module of the data stored in such storage devices and means for receiving the data thus read by the said module which is transmitted to it.

13. A terminal in accordance with claim 12, characterised in that the said sequence of operations also includes:
transmission to the user of the telephone terminal of a message transmitted in response by the management server to the said terminal,

14. A system for monitoring moving objects or for their remote control, incorporating a remote management server, a device that can be attached to moving objects to permit their identification, means for automatically reading a code stored in this identification device and remotely interrogating the management server, characterised in that the device incorporates a code reading module connected to a mobile telephone terminal, the code reading module incorporating means for transmitting to the mobile telephone terminal a read code, the said mobile telephone terminal incorporating means for initiating and managing a sequence of operations including in order:
reading by the said module of the code stored in the identification device,
transmission of the said code to the management server by the said telephone terminal,
transmission to the user of the telephone terminal of a message transmitted in response by the said database to the said terminal.
